(19) United States
(12) Patent Application Publication
(10) Pub. No.: US 2005/0154933 A1
(43) Pub. Date: Jul. 14, 2005

(54) System and method for wake on wireless lan

(76) Inventors: Tseng Jan Hsu, Pleasanton, CA (US); Zhengjin Shu, San Jose, CA (US)

Correspondence Address: PILLSBURY WINTHROP SHAW PITTMAN LLP, 2475 HANOVER STREET, PALO ALTO, CA, 94304-1114, US

(21) Appl. No.: 10/898,461

(22) Filed: Jul. 22, 2004

Related U.S. Application Data
(60) Provisional application No. 60/489,408, filed on Jul. 22, 2003.
(60) Provisional application No. 60/489,399, filed on Jul. 22, 2003.

(51) Int. Cl. G06F 1/26; G06F 1/32

(52) U.S. Cl. 713/320; 713/300; 713/324

(57) ABSTRACT

A system and method for energy conservation in wireless networks includes techniques for powering down a Soft AP device while still maintaining compliance with the “always on” requirement for access points in wireless networks. The system and method includes a technique for causing a host system having a Soft AP device integrated therein to go into a low power, or energy conservation mode when no wireless activity has occurred over a predetermined period, and for monitoring to identify appropriate signals even while in the low power mode. If an appropriate signal is detected, a wake up signal is generated and the host system, including the Soft AP device, is returned to normal functionality.

### RELATED APPLICATIONS

This application claims the benefit of and incorporates by reference U.S. Provisional Patent Applications Ser. No. 60/489,408, filed Jul. 22, 2003 and entitled System and Method for Wake on Wireless LAN and Ser. No. 60/489,399, filed Jul. 22, 2003, and entitled Method and Apparatus for Automatic Configuration of Wireless Networks, and further is related to commonly owned and concurrently filed U.S. patent application Ser. No. ______ entitled “Method And Apparatus For Automatic Configuration Of Wireless Networks”, with attorney docket number 069509-0310686 (client reference PCTEL-13200), which is incorporated herein by reference in its entirety.

### FIELD OF THE INVENTION

The present invention relates to wireless networking, and more particularly relates to methods and techniques for power conservation within a wireless environment.

### BACKGROUND OF THE INVENTION

Wireless networking is becoming an attractive solution for local network access. However, numerous issues continue to prevent wireless networking from becoming ubiquitous. Among these are power management and energy conservation issues. Substantially powering down a personal computer to reduce power consumption, conserve energy and, for mobile devices, extend battery life, is well known with regard to monitors, disk drives, and certain other ancillary functions. However, historically it has been difficult to power down other devices for purposes of conserving energy, including, in particular, wireless access points and related devices, since the need for response by these devices can vary unpredictably.

### SUMMARY OF THE INVENTION

In a wireless networking environment, an access point provides a link between the wired network and the wireless network. In wireless environments such as that specified by the IEEE 802.11 specification, it is assumed that the access point is “always on”, or always able to respond to appropriate signals from transceivers seeking to link to the network through that access point.

Recently, software-based access points (or Soft AP) have been developed. For purposes of the present invention, a simple Soft AP implementation can comprise a hardware WiFi adapter together with appropriate driver software running on the host to execute the access point functions. More robust Soft AP implementations, such as that described in the Related Application referenced above, can provide additional functionality.

To provide more robust energy conservation, the present invention provides a method for allowing a Soft AP to enter a “waiting” mode where power consumption is reduced. In a typical implementation, a “power down time” period is set in the Soft AP. If no WiFi activity occurs for that period, the Soft AP will go into a power-saving mode (i.e., a waiting mode) thereby allowing the host PC to also go into a power-saving state. In this exemplary arrangement, no WiFi activity means that there has been no connection with any wireless station, including, for example, no power saving services and no detection of scanning by a wireless station.

In waiting mode, the present invention includes mechanisms to cause the WiFi hardware adapter to continue to “listen” for appropriate radio signals. If an appropriate radio signal is received from, for example, a WiFi device seeking a communications link, the invention causes the WiFi hardware adapter to generate a standard “power management enable” signal to wake up the host PC, and likewise to wake up the Soft AP functions, which powers up the WiFi hardware for normal function.

### THE FIGURES

FIG. 1 illustrates a typical Soft AP configuration wherein a PC having the Soft AP integrated therein provides an access point to PC1 and PC2.

FIG. 2 illustrates a power down process in accordance with the present invention.

FIG. 3 illustrates a wakeup process in accordance with the present invention.

### DETAILED DESCRIPTION OF THE INVENTION

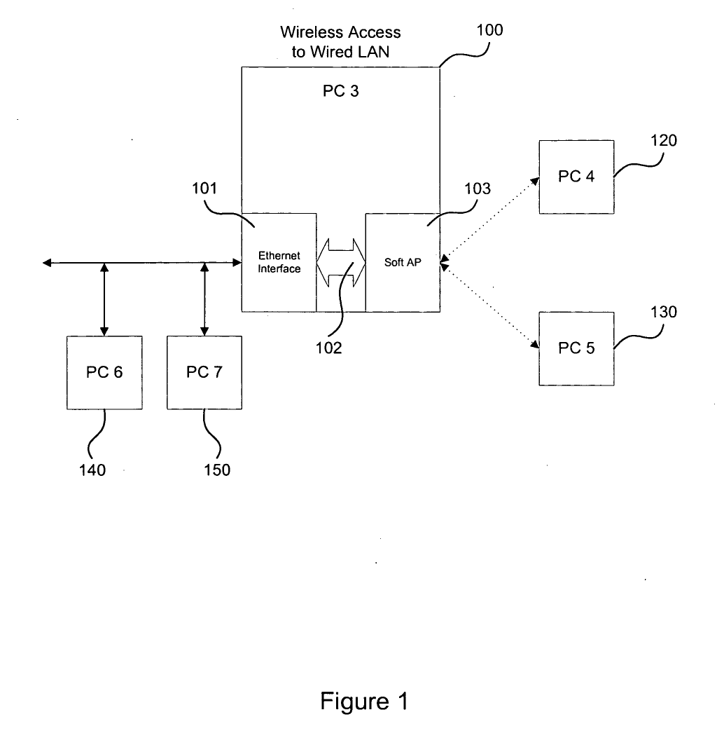

Referring first to FIG. 1, a system incorporating a Soft AP such as utilized in the present invention may be better appreciated. In particular, FIG. 1 illustrates a Soft AP device serving as an access point between wired and wireless devices according to an embodiment of the present invention. As shown in FIG. 1, the Soft AP host PC 3 (100) acts as a wireless access point for wireless PC stations (120, 130), bridging them to wired PC stations (140, 150). Such a MAC layer bridge (102) of the present invention merges the wireless LAN with the wired LAN by bridging the wired Ethernet interface (101) and the Soft AP network interface (103). This bridge forms a single logical LAN of all PC stations, including the Soft AP host PC 3 (100). Note that the bridge (202) between the wireless and the wired networks of PC stations are transparent to Layer 3 protocols such that a wireless PC station on one side of the Soft AP host PC 3 (100) can directly talk to a wired PC station on the other side of the Soft AP host PC 3 (100) without going through a layer 3 proxy or gateway. An example of this embodiment of the present invention includes a Windows XP built-in MAC Bridge Miniport Driver that can be used to bridge the Ethernet network interface (101) and the Soft AP network interface (103). It will, of course, be appreciated that the Soft AP host need not be a personal computer, but could instead be any device capable of performing the functions of a Soft AP as described herein. Thus, in addition to a desktop or laptop PC, the Soft AP host could be a pocket PC, tablet, PDA, cell phone, or other suitable device. For the sake of convenience, reference to a PC or host device hereinafter is intended to mean reference to any suitably configured device including those specifically described herein.

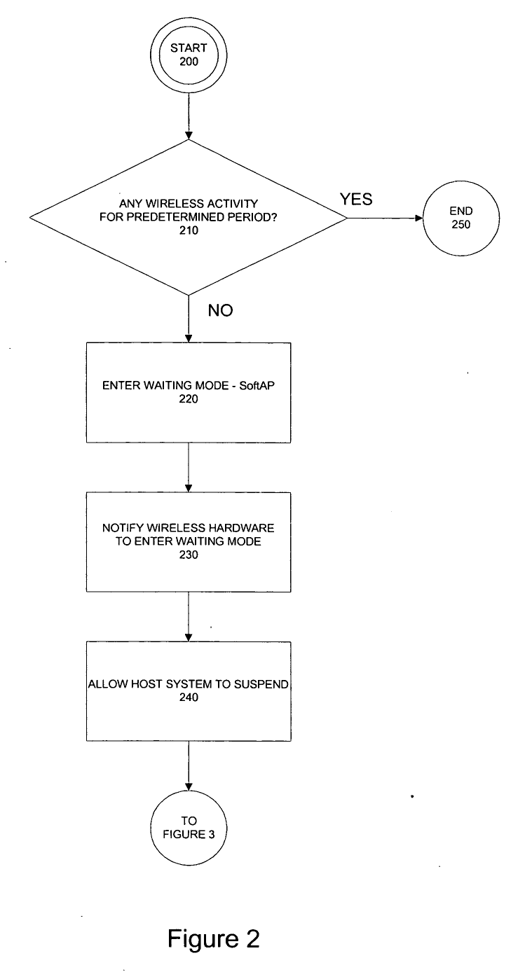

Referring next to FIG. 2, an exemplary arrangement of a power down process in accordance with the present invention may be better understood. The process begins at 200, and at 210 checks to determine whether any WiFi activity has been detected for a preset period of time. If activity has been detected, the process terminates and the PC continues in normal mode. Alternatively, the process restarts at 200, and repeat itself indefinitely.

However, if the result of the check at step 210 is that no wireless activity, for example WiFi or 802.11 activity, has occurred within the preset period, then the Soft AP enters a waiting mode as shown at step 220. In this example, the absence of wireless activity means, for example, that there is no current connection to a wireless device, nor has there been such a connection for the predetermined period. As one example, the predetermined period may be ten minutes, or some greater or lesser period as selected by the user for his convenience. In addition, the absence of wireless activity typically includes the absence of power saving services and a lack of detection of scanning by any mobile station. When the Soft AP enters the waiting mode, the wireless hardware in the host system is notified to go to a low power waiting mode, as shown at step 230. The host may also enter a suspend or deep sleep mode, in accordance with the power conservation configuration of the host, as shown at step 240.

Once the Soft AP enters the waiting mode as shown at step 220, an exemplary implementation remains fully compliant with the power management protocol of the host system 103. If the power management configuration of the host system is ready to suspend or otherwise power down, the Soft AP implementation is configured to allow the host system to suspend.

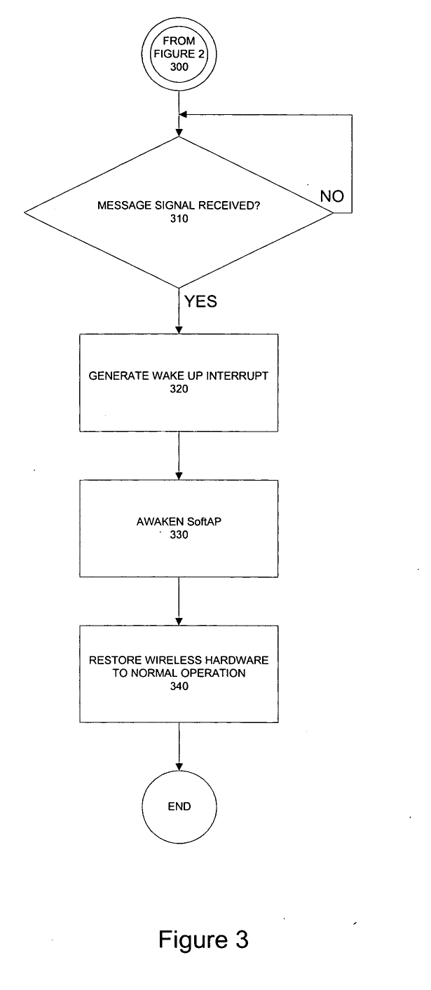

Referring next to FIG. 3, the operation of the host system in the waiting mode and during wakeup can be better appreciated. The process starts with the host in waiting mode, as shown at 300. In waiting mode, the wireless adapter continues to listen for a radio signal from a station seeking to communicate with the host, by checking periodically to see if such a signal has been received as shown at step 310. If no such signal is received, the Soft AP remains in waiting mode.

However, if the check at step 310 shows a signal has been received, such as indicated by a message having a meaningful preamble, typically indicated by signal characteristics of the preamble as defined in the relevant industry standards, the wireless adapter in the host system causes a standard “power management enable” interrupt signal to be generated as shown at step 320, to wake up the host system. For example, a PME signal may be used on the PCI bus, or a “wake up” signal may be used by USB. When the host system is awakened, it also causes the Soft AP to be awakened, as shown at step 330, and in turn the WiFi or other wireless hardware is returned to a fully powered state as shown at step 340 and all normal functions are restarted.

A variety of techniques may be used to detect the presence of a client station's signal while the host system is in the waiting mode. In a first exemplary arrangement where active scan is used, the wireless chipset, which again may be a WiFi chipset, may be configured to maintain power only to the radio receiver portion of the chipset. In this manner, the wireless chipset is configured as a low power “simple” receiver to detect a message having a meaningful preamble. If such a message is received, the wake up signal is generated as discussed above. This approach conserves the most power, and is therefore attractive for at least some laptop-based implementations.

Alternatively, if the wireless adapter has its own power supply, for example an external supply for a USB device, the wireless chipset may be configured to continue to send out a beacon to alert mobile stations of the presence of the access point. Alternatively, the device may be configured to provide power only to the receiver as described above. In addition, combinations of these arrangements may be selected.

One such combination involves dynamically switching between the two example alternatives according to the time pattern of the wireless activities. For instance, an externally powered AP device may be powered to send out beacons and at the same time detect signals from wireless stations in range for a predetermined period of time during which the host computing device are in suspend mode. If by the end of said period, there has been no wireless signal detected from a wireless station, the AP device may then go into a “simple receiver mode” in which only meaningful preambles are detected without sending out wireless beacons, whereby conserving more power.

From the foregoing it can be appreciated that a new and novel method for power conservation in a host system having integrated therein a Soft AP device has been disclosed. Having fully described an embodiment of the invention and various alternatives, those skilled in the art will recognize, given the teachings herein, that numerous alternatives and equivalents exist which do not depart from the invention. It is therefore intended that the invention not be limited by the foregoing description, but only by the appended claims.

1. A method for reducing energy consumption in a software-based wireless access point for computer networking comprising the steps of
monitoring activity on the access point for a predetermined period,
causing the access point to enter a power-saving mode when no activity occurs on the access point for the predetermined period, and
restoring the access point to normal functionality when a request for communications with the access point is detected.

2. The method of claim 1 wherein a request for communication is communicated by a radio signal.

3. The method of claim 1 wherein the restoring step includes generating a standard power management enable signal to wake a host computer.

4. A recording medium for recording in a computer-readable fashion a program for cooperating with a wireless network access device operatively connected to a host computer to cause the wireless network access device to operate as a software-based access point, the recording medium having instructions to perform the following steps on a microprocessor:
monitoring the activity of the wireless network access device,
in response to a lack of activity for a predetermined period of time, selectively powering down portions of the network access device while maintaining the ability to detect requests for communication with the network access device, and
responding to a request for communication by restoring full functionality.

5. A system for reducing power to a wireless network access device comprising
a microprocessor,
memory operatively connected to the microprocessor for storing data,
a timer for determining when a lack of activity has continued for a predetermined period,
a command program stored in the memory for removing power to a portion of the wireless network access device while still monitoring requests for communication with he access device, the command program further causing the restoration of power to the wireless network access device in response to a request for communication.
